(19) United States
(12) Patent Application Publication
(10) Pub. No.: US 2006/0131961 A1
(43) Pub. Date: Jun. 22, 2006

(54) Multi-output power supply circuit

(75) Inventors: Takuya Ishii, Osaka-Shi (JP); Takashi Ryu, Kyoto-Shi (JP); Mikio Motomori, Osaka-Fu (JP); Hiroki Akashi, Hirakata-shi (JP); Hirohisa Tanabe, Nagaokakyo-shi (JP); Makoto Ishimaru, Takatsuki-shi (JP); Tomoya Shigemi, Takatsuki-shi (JP); Masato Yoshida, Takatsuki-shi (JP)

Correspondence Address: GREGORY A. STOBBS, 5445 CORPORATE DRIVE, SUITE 400, TROY, MI, 48098, US

(73) Assignee: Matsushita Electric Industrial Co., Ltd., Osaka (JP)

(21) Appl. No.: 11/283,582

(22) Filed: Nov. 18, 2005

(30) Foreign Application Priority Data
Nov. 19, 2004 (JP) 2004-336543

(51) Int. Cl. H02J 3/14; H02J 1/00

(52) U.S. Cl. 307/31

(57) ABSTRACT

A multi-output power supply circuit comprising a switching circuit 10 having a series circuit of a high-side switch 11 and a low-side switch 12, connected in parallel with an input DC power supply 1, and a step-down control circuit 13, and multiple step-up circuits 20 and 30 connected to the output terminal of the switching circuit, wherein each step-up circuit has an inductor connected to the output terminal of the switching circuit, a step-up switch, a step-up rectifier, smoothing means for outputting an output DC voltage, and a step-up control circuit for driving the step-up switch.

### BACKGROUND OF THE INVENTION

The present invention relates to a multi-output power supply circuit having multiple outputs including outputs that can be step-up/down controlled with respect to an input DC voltage.

As a multi-output power supply circuit, to which power is supplied from an input DC power supply and from which multiple power supply voltages are output to various electronic circuits, a multi-output power supply circuit that outputs constant output voltages even in the case that an input DC voltage changes in the range from a voltage higher than each output voltage to a voltage lower than the output voltage has been developed in recent years. This kind of conventional multi-output power supply circuit is disclosed in Japanese Official Gazette of Unexamined Patent Publication No. Hei 8-205528, for example.

FIG. 6 is a circuit diagram showing the configuration of the conventional multi-output power supply circuit disclosed in Japanese Official Gazette of Unexamined Patent Publication No. Hei 8-205528. As shown in FIG. 6, an input DC power supply 1 outputs an input DC voltage Vi to a voltage limiting circuit 100, and the voltage limiting circuit 100 comprises a P-channel first FET 101, a first diode 102, a first choke coil 103, a first capacitor 104 and a first control circuit 105. 3-1 The source of the first FET 101 is connected to the input DC power supply 1, and the cathode of the first diode 102 is connected to the drain of the first FET 101. The anode of the first diode 102 is grounded. One terminal of the first choke coil 103 is connected to the connection point of the drain of the first FET 101 and the cathode of the first diode 102, and one electrode of the first capacitor 104 is connected to the other terminal of the first choke coil 103. The other terminal of the first capacitor 104 is grounded. The first control circuit 105 carries out control to open/close the first FET 101 by applying a pulse voltage to the gate of the first FET 101 to maintain the voltage V1 of the first capacitor 104 at a limit voltage Vlim. The voltage limiting circuit 100 is set to positively maintain the first FET 101 in the closed state in the case that the input DC voltage Vi is equal to or less than the limit voltage Vlim.

As shown in FIG. 6, a first step-up circuit 200 and a second step-up circuit 300 are connected to the voltage limiting circuit 100. The first step-up circuit 200 comprises a second choke coil 201, a second FET 202, a second diode 203, a second capacitor 204 and a second control circuit 205. The second step-up circuit 300 comprises a third choke coil 301, a third FET 302, a third diode 303, a third capacitor 304 and a third control circuit 305.

In the first step-up circuit 200, one terminal of the second choke coil 201 is connected to the first capacitor 1.04, and the other terminal of the second choke coil 201 is connected to the drain of the N-channel second FET 202. The source of the second FET 202 is grounded. The anode of the second diode 203 is connected to the connection point of the second choke coil 201 and the second FET 202. One electrode of the second capacitor 204 is connected to the cathode of the second diode 203, and the other electrode of the second capacitor 204 is grounded. The second capacitor 204 outputs an output DC voltage Vo2. The second control circuit 205 carries out control to open/close the second FET 202 by applying a pulse voltage to the gate of the second FET 202 to maintain the output DC voltage Vo2 at a desired voltage.

The second step-up circuit 300 is connected in parallel with the first step-up circuit 200 and configured so as to be similar to the first step-up circuit 200. In the second step-up circuit 300, the output V1 of the voltage limiting circuit 100 is input, and an output DC voltage Vo3 is output from the third capacitor 304. The third control circuit 305 carries out control to open/close the third FET 302 by applying a pulse voltage to the gate of the third FET 302 to maintain the output DC voltage Vo3 at a desired voltage.

The operation of the conventional multi-output power supply circuit shown in FIG. 6 will be described next. In the case that the input DC voltage Vi is higher than the limit voltage Vlim, the first FET 101 is opened/closed by a drive signal supplied from the control circuit 105 to the gate thereof. By this ON/OFF operation of the first FET 101, a rectangular-wave voltage having a pulse width corresponding to the ON/OFF time of the first FET 101 and also having an amplitude of approximately Vi is generated at the drain of the first FET 101. This rectangular-wave voltage is smoothened using a low-pass filter comprising the first choke coil 103 and the first capacitor 104, and a DC voltage being equal to the average value of the rectangular-wave voltage described above is generated across the first capacitor 104. When it is herein assumed that a duty ratio D1 is the ratio of the time of the closed state of the first FET 101 with respect to the repetition cycle of the drive signal supplied to the first FET 101, the DC voltage V1 generated across the first capacitor 104 is represented by the relationship given by Expression (1) described below.
V1=Vi×D1 (1)

In other words, as the duty ratio D1 is made larger, the voltage V1 becomes higher. Conversely, as the duty ratio D1 is made smaller, the voltage V1 becomes lower. The first control circuit 105 adjusts the duty ratio D1 in response to the change in the input DC voltage Vi and the change in load so that the voltage V1 becomes equal to the limit voltage Vlim having been set beforehand.

Next, in the case that the input DC voltage Vi is equal to or less than the limit voltage Vlim, the duty ratio D1 is 100side %, the first FET 101 is closed at all times, and a voltage nearly equal to the input DC voltage Vi is generated across the first capacitor 104.

The output V1 of the voltage limiting circuit 100 is the input voltage of the first step-up circuit 200. In the first step-up circuit 200, the second FET 202 is opened/closed by the drive signal from the second control circuit 205. In the period during which the second FET 202 is closed, the input DC voltage Vi is applied to the second choke coil 201. In the period during which the second FET 202 is open, the second diode 203 is turned ON by the counter-electromotive force of the second choke coil 201, and the second capacitor 204 is charged. When it is herein assumed that a duty ratio D2 is the ratio of the time of the closed state of the second FET 202 with respect to the repetition cycle of the drive signal supplied to the second FET 202, the output DC voltage Vo2 generated across the second capacitor 204 is represented by the relationship given by Expression (2) described below.
Vo2=V1/(1−D2) (2)

In other words, the output DC voltage Vo2 is higher than the voltage V1 across the first capacitor 104. As the duty ratio D2 is made larger, the output DC voltage Vo2 becomes higher. Conversely, as the duty ratio D2 is made smaller, the output DC voltage Vo2 becomes lower. The second control circuit 205 adjusts the duty ratio D2 in response to the change in the input/output conditions, whereby the first step-up circuit 200 operates so that the output DC voltage Vo2 becomes the desired voltage.

Similarly, the third control circuit 305 opens/closes the third FET 302 to adjust its duty ratio D3, whereby the second step-up circuit 300 operates so that the output DC voltage Vo3 becomes the desired voltage.

Multi-output power supply circuits are used as power supplies that are built in various kinds of electronic apparatuses. Hence, making such multi-output power supply circuits smaller in size and higher in efficiency is a very important issue in this field. In the configuration of the conventional multi-output power supply circuit described above, the voltage limiting circuit 100, to which the input DC voltage Vi is input and from which the DC voltage V1 being equal to or less than the input DC voltage Vi is output, is a step-down circuit, and this step-down circuit is connected in series with the step-up circuits. For this reason, the conventional multi-output power supply circuit has a problem of being difficult to settle the issue of downsizing because of the use of numerous components and also has a problem of being unable to generate the input DC voltage Vi having a desired voltage at high power conversion efficiency.

### SUMMARY OF THE INVENTION

The present invention is intended to solve the conventional problems described above and to provide a multi-output power supply circuit capable of carrying out desired step-up/down control for an input DC voltage and capable of generating constant outputs at high power conversion efficiency using a simple configuration having a limited number of components.

For the purpose of attaining the objects described above, a multi-output power supply circuit in accordance with a first aspect of the present invention comprises:

a switching circuit having a series circuit of a high-side switch and a low-side switch, connected in parallel with an input DC power supply, and a step-down control circuit for alternately opening/closing the high-side switch and the low-side switch, and

multiple step-up circuits each connected to the connection point of the high-side switch and the low-side switch.

The multi-output power supply circuit in accordance with the first aspect of the present invention, configured as described above, can carry out desired step-up/down control for an input DC voltage and can generate constant outputs at high power conversion efficiency using a simple configuration having a limited number of components.

A multi-output power supply circuit in accordance with a second aspect of the present invention is characterized in that the step-up circuit in accordance with the first aspect comprises:

an inductor, one terminal of which is connected to the connection point of the high-side switch and the low-side switch,

a step-up switch and a step-up rectifier connected to the other terminal of the inductor,

smoothing means, connected to the step-up rectifier, for outputting an output DC voltage, and

a step-up control circuit for controlling the ON/OFF operation of the step-up switch so as to control the output DC voltage. The multi-output power supply circuit in accordance with the second aspect of the present invention, configured as described above, can securely carry out step-up/down control for the input DC voltage using a simple configuration.

A multi-output power supply circuit in accordance with a third aspect of the present invention is characterized in that the step-down control circuit and the step-up control circuit in accordance with the first aspect are configured so as to drive the high-side switch and the low-side switch, and the step-up switch, respectively, at the same switching frequency. The multi-output power supply circuit in accordance with the third aspect of the present invention, configured as described above, can carry out desired step-up/down control and can securely generate constant outputs using a simple configuration.

A multi-output power supply circuit in accordance with a fourth aspect of the present invention is characterized in that the step-down control circuit in accordance with the first aspect is configured that the ratio of the ON time with respect to the switching cycle of the high-side switch is set so as to be equal to or less than the ratio of the minimum value of the output DC voltages output from the multiple step-up circuits with respect to the input voltage output from the input DC power supply. The multi-output power supply circuit in accordance with the fourth aspect of the present invention, configured as described above, can carry out desired step-up/down control using a simple configuration.

A multi-output power supply circuit in accordance with a fifth aspect of the present invention comprises:

a switching circuit having a series circuit of a high-side switch and a low-side switch, connected in parallel with an input DC power supply, and a step-down control circuit for alternately opening/closing the high-side switch and the low-side switch,

a smoothing circuit, connected to the connection point of the high-side switch and the low-side switch, for outputting a first output DC voltage, and

at least one step-up circuit connected to the connection point of the high-side switch and the low-side switch.

The multi-output power supply circuit in accordance with the fifth aspect of the present invention, configured as described above, can carry out desired step-down control and step-up/down control and can securely generate desired multiple constant outputs using a simple configuration.

A multi-output power supply circuit in accordance with a sixth aspect of the present invention is characterized in that the step-up circuit in accordance with the fifth aspect comprises:

an inductor, one terminal of which is connected to the connection point of the high-side switch and the low-side switch,

a step-up switch and a step-up rectifier connected to the other terminal of the inductor,

smoothing means, connected to the step-up rectifier, for outputting an output DC voltage, and

a step-up control circuit for controlling the ON/OFF operation of the step-up switch so as to control the output DC voltage. The multi-output power supply circuit in accordance with the sixth aspect of the present invention, configured as described above, can carry out desired step-up/down control using a simple configuration.

A multi-output power supply circuit in accordance with a seventh aspect of the present invention is characterized in that the smoothing circuit in accordance with the fifth aspect comprises an inductor, one terminal of which is connected to the connection point of the high-side switch and the low-side switch, and a capacitor connected to the other terminal of the inductor so as to output the first output DC voltage from across the capacitor. The multi-output power supply circuit in accordance with the seventh aspect of the present invention, configured as described above, can carry out desired step-down control using a simple configuration.

A multi-output power supply circuit in accordance with an eighth aspect of the present invention is characterized in that the step-down control circuit in accordance with the fifth aspect controls the ON/OFF operation of the high-side switch and the low-side switch so as to control the first output DC voltage. The multi-output power supply circuit in accordance with the eighth aspect of the present invention, configured as described above, can carry out desired step-up/down control for the input DC voltage using a simple configuration.

A multi-output power supply circuit in accordance with a ninth aspect of the present invention is characterized in that the step-down control circuit and the step-up control circuit in accordance with the sixth aspect are configured so as to drive the high-side switch and the low-side switch, and the step-up switch, respectively, at the same switching frequency. The multi-output power supply circuit in accordance with the ninth aspect of the present invention, configured as described above, can carry out desired step-up/down control for the input DC voltage using a simple configuration.

The multi-output power supply circuit in accordance with the present invention can obtain desired multiple outputs that can be step-up/down controlled with respect to an input DC voltage using a limited number of components.

Furthermore, the multi-output power supply circuit in accordance with the present invention can obtain a desired output that can be step-down controlled and at least one desired output that can be step-up/down controlled with respect to an input DC voltage.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF THE DRAWINGS

FIG. 1 is a circuit diagram showing the configuration of a multi-output power supply circuit in accordance with a first embodiment of the present invention;

FIG. 2 is a waveform diagram showing the operations of the various sections of the multi-output power supply circuit in accordance with the first embodiment;

FIG. 3 is a circuit diagram showing the configurations of the main sections of the multi-output power supply circuit in accordance with the first embodiment;

FIG. 4 is a circuit diagram showing the configuration of a multi-output power supply circuit in accordance with a second embodiment of the present invention;

FIG. 5 is a circuit diagram showing the configuration of a multi-output power supply circuit in accordance with a third embodiment of the present invention; and

FIG. 6 is the circuit diagram showing the configuration of the conventional multi-output power supply circuit.

It will be recognized that some or all of the figures are schematic representations for purposes of illustration and do not necessarily depict the actual relative sizes or locations of the elements shown.

### DETAILED DESCRIPTION OF THE PREFERRED EMBODIMENT

Preferred embodiments of a multi-output power supply circuit in accordance with the present invention will be described below referring to the accompanying drawings.

### First Embodiment

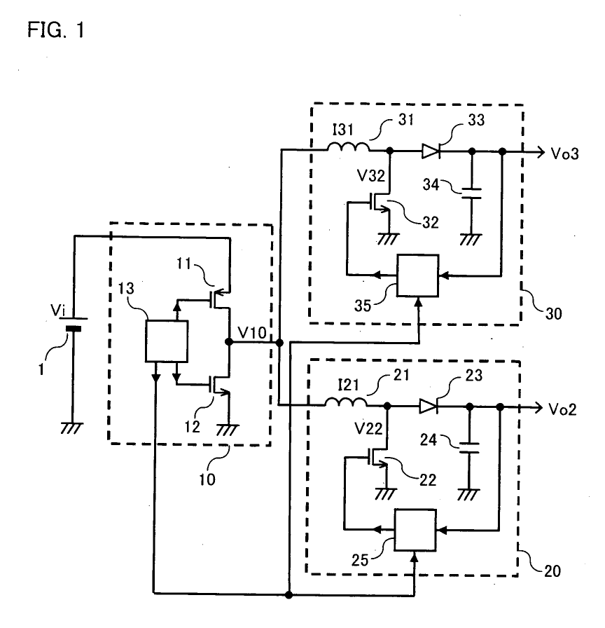

FIG. 1 is a circuit diagram showing the configuration of a multi-output power supply circuit in accordance with a first embodiment of the present invention.

As shown in FIG. 1, the multi-output power supply circuit in accordance with the first embodiment comprises a switching circuit 10 to which an input DC power supply 1 for outputting an input DC voltage Vi is connected, and step-up circuits 20 and 30 for generating two outputs.

The switching circuit 10 comprises a high-side switch 11, a low-side switch 12 and a step-down control circuit 13. The high-side switch 11 is formed of a P-channel FET, the source of which is connected to the input DC power supply 1. The low-side switch 12 is formed of an N-channel FET, the drain of which is connected to the drain of the high-side switch 11 and the source of which is grounded. The step-down control circuit 13 carries out control to alternately open/close the high-side switch 11 and the low-side switch 12 in response to a predetermined switching cycle T and a predetermined pulse width by applying a pulse voltage to the gates of the high-side switch 11 and the low-side switch 12. The connection point of the high-side switch 11 and the low-side switch 12 is the output terminal of the switching circuit 10.

In the first step-up circuit 20, one terminal of an inductor 21 is connected to the output terminal of the switching circuit 10. A step-up switch 22 is formed of an N-channel FET, the drain of which is connected to the other terminal of the inductor 21 and the source of which is grounded. The anode of a step-up rectifier 23 is connected to the connection point of the inductor 21 and the step-up switch 22. A smoothing means 24 is formed of a capacitor, one electrode of which is connected to the cathode of the step-up rectifier 23 and the other electrode of which is grounded. An output DC voltage Vo2 is output from the smoothing means 24. A step-up control circuit 25 carries out control to open/close the step-up switch 22 by applying a pulse voltage to the gate of the step-up switch 22 to maintain the output DC voltage Vo2 at a desired constant voltage. As described above, the first step-up circuit 20 comprises the inductor 21, the step-up switch 22, the step-up rectifier 23, the smoothing means 24 and the step-up control circuit 25.

Like the first step-up circuit 20, the second step-up circuit 30 comprises a inductor 31, a step-up switch 32, a step-up rectifier 33, a smoothing means 34 and a step-up control circuit 35. The second step-up circuit 30 is connected in parallel with the first step-up circuit 20. The output of the switching circuit 10 is input to the second step-up circuit 30, and an output DC voltage Vo3 is output from the smoothing means 34.

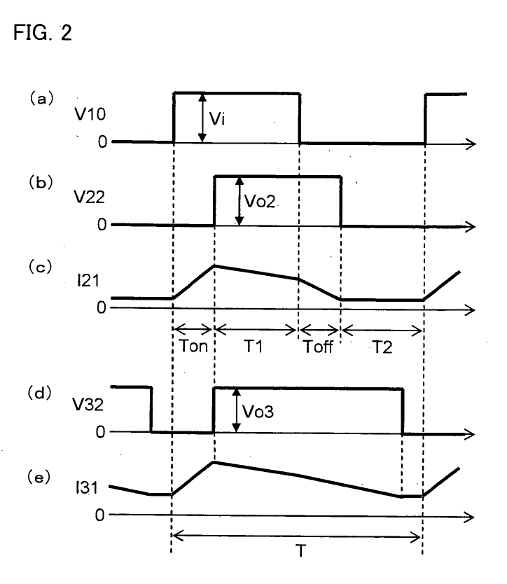

FIG. 2 is a waveform diagram showing the operations of the various sections of the multi-output power supply circuit in accordance with the first embodiment. In FIG. 2, (a) shows the output terminal voltage V10 of the switching circuit 10, (b) shows the drain voltage V22 of the step-up switch 22, (c) shows the current I21 of the inductor 21, (d) shows the drain voltage V32 of the step-up switch 32, and (e) shows the current I31 of the inductor 31.

First, as shown in (a) of FIG. 2, since the high-side switch 11 and the low-side switch 12 are opened/closed alternately, the output terminal voltage V10 of the switching circuit 10 has a rectangular-wave voltage, the amplitude of which is the input DC voltage Vi. The ratio of the ON time during which the high-side switch 11 is closed with respect to the switching cycle T is herein referred to as a duty ratio D1.

Next, as shown in (b) of FIG. 2, the drain voltage V22 of the step-up switch 22 of the first step-up circuit 20 is a rectangular-wave voltage, the amplitude of which is the output DC voltage Vo2, when the voltage drop during the conduction time of the step-up rectifier 23 is ignored. In the multi-output power supply circuit in accordance with the first embodiment, the step-up control circuit 25 operates in synchronization with the step-down control circuit 13 of the switching circuit 10, and the step-up switch 22 is opened/closed in synchronization with the switching circuit 10 at the same switching cycle T.

In the first embodiment, it is assumed that the timing of opening the step-up switch 22 after a predetermined time (Ton) has passed after the closing of the high-side switch 11 of the switching circuit 10 and of closing the step-up switch 22 using the step-up control circuit 25 is set to maintain the output DC voltage Vo2 at a desired constant voltage. The ratio of the ON time during which the step-up switch 22 is closed with respect to the switching cycle T is referred to as a duty ratio D2.

Within the switching cycle T, in time Ton during which both the high-side switch 11 and the step-up switch 22 are closed, the input DC voltage Vi is applied to the inductor 21. At this time, the current of the inductor 21 increases as indicated in (c) of FIG. 2. Next, in time T1 during which the high-side switch 11 is closed and the step-up switch 22 is open, an input/output voltage difference (Vi−Vo2) is applied to the inductor 21. At this time, the current of the inductor 21 increases when Vi>Vo2, becomes constant when Vi=Vo2, and decreases when Vi<Vo2. Next, in time Toff during which both the high-side switch 11 and the step-up switch 22 are open, the output DC voltage Vo2 is applied to the inductor 21 in the opposite direction. At this time, the current of the inductor 21 decreases. Furthermore, in time T2 during which the high-side switch 11 is open and the step-up switch 22 is closed, the inductor 21 is short-circuited, no voltage is applied thereto, and the current of the inductor 21 maintains a constant value. The increase and decrease of the current flowing through the inductor 21 correspond to the increase and decrease of the magnetic flux in the inductor 21. A conditional expression wherein the increase and decrease of the current are balanced, that is, the increase and decrease of the magnetic flux are balanced, within one switching cycle is represented by Expression (3) described below.
Vi×Ton+(Vi−Vo2)×T1=Vo2×Toff (3)

In the first embodiment, the times T, T1, Ton and Toff have relationships represented by Expressions (4) and (5).
Ton+T1=D1×T (4)
Toff+T1=(1−D2)×T (5)

Hence, an input/output relationship expression described below is obtained.
Vo2=Vi×D1/(1−D2) (6)

As understood from the input/output relationship expression, Expression (6) described above, as the duty ratios D1 and D2 are made larger, the output DC voltage Vo2 becomes higher. Conversely, as the duty ratios are made smaller, the output DC voltage Vo2 becomes lower. The step-down control circuit 13 fixes the duty ratio D1, and the step-up control circuit 25 adjusts the duty ratio D2 in response to the change in the input/output conditions. As a result, the first step-up circuit 20 operates so that the output DC voltage Vo2 becomes equal to the desired constant voltage.

Similarly, when it is assumed that the duty ratio at which the step-up control circuit 35 opens/closes the step-up switch 32 is D3, an input/output relationship expression, Expression (7) described below, is obtained with respect to the output DC voltage Vo3 of the second step-up circuit 30.
Vo3=Vi×D1/(1−D3) (7)

Hence, as the duty ratios D1 and D3 are made larger, the output DC voltage Vo3 becomes higher. Conversely, as the duty ratios are made smaller, the output DC voltage Vo3 becomes lower. The step-up control circuit 35 adjusts the duty ratio D3 in response to the change in the input/output conditions. As a result, the second step-up circuit 30 makes adjustment so that the output DC voltage Vo3 becomes equal to the desired constant voltage.

In the first embodiment, a case of having two outputs (Vo2 and Vo3) has been described. However, the number of outputs can be increased by adding circuits having configurations similar to those of the first step-up circuit 20 and the second step-up circuit 30. In operation principle, it does not matter how many outputs are used.

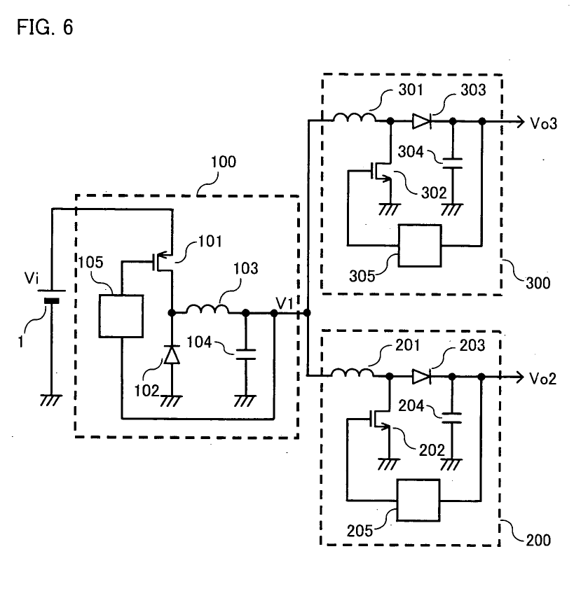

As described above, the multi-output power supply circuit in accordance with the first embodiment of the present invention is configured that the number of the inductors and the number of capacitors are each reduced by one in comparison with the conventional configuration shown in FIG. 6 and is also configured so as to be able to control multiple step-up/down outputs. In addition, since the multi-output power supply circuit in accordance with the first embodiment is configured that the step-up circuits are directly connected to the switching circuit, it is possible to obtain high power conversion efficiency.

The multi-output power supply circuit in accordance with the first embodiment is configured that the step-up control circuit 25 adjusts the duty ratio D2 of the step-up switch 22 and that the step-up control circuit 35 adjusts the duty ratio D3 of the step-up switch 32, thereby controlling the output DC voltages Vo2 and Vo3, respectively. However, the output DC voltages are limited by the input DC voltage Vi and the duty ratio D1. For example, even if the step-up control circuit 25 sets the duty ratio D2 at zero, the output DC voltage Vo2 is represented by Vo2=Vi×D1 according to the input/output relationship expression described above, and this becomes the lower limit value of the output DC voltage Vo2. The above description is similarly applicable to the output DC voltage Vo3. In other words, in the step-down control circuit 13, when the input DC voltage Vi has its maximum value Vimax, it is necessary to set the duty ratio D1 so that the Vimax×D1 becomes equal to or less than the minimum value of the desired output DC voltages.

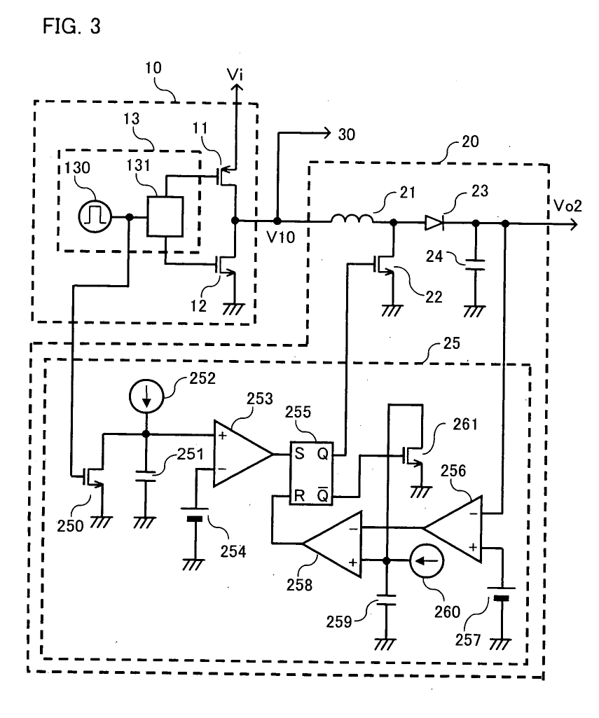

Furthermore, in the first embodiment, it is assumed that the timing of opening the step-up switches 22 and 32 after a predetermined time (Ton) has passed after the closing of the high-side switch 11 of the switching circuit 10 and of closing the step-up switches 22 and 32 using the step-up control circuits 25 and 35 is set to maintain the output DC voltages Vo2 and Vo3 at the desired constant voltages. FIG. 3 is a view showing specific circuit examples of the step-up control circuit 25 and the step-down control circuit 13 of the switching circuit 10.

In FIG. 3, the step-down control circuit 13 of the switching circuit 10 comprises a pulse generation circuit 130 for outputting a pulse voltage having a predetermined pulse width and a drive circuit 131 for power-amplifying the pulse voltage and for outputting the amplified pulse voltage to the gate of the high-side switch 11 and the gate of the low-side switch 12. The pulse voltage from the pulse generation circuit 130 is input to the gate of the N-channel FET 250 of the step-up control circuit 25. In other words, the FET 250 serves as a switch that is closed when the high-side switch 11 is open. The capacitor 251 connected in parallel with the FET 250 is discharged to zero voltage when the high-side switch 11 is open and is charged by a constant current using a current supply 252 when the high-side switch 11 is closed. The voltage of the capacitor 251 is compared with the reference voltage of a reference voltage supply 254 using a comparator 253. When the high-side switch 11 is closed, the capacitor 251 is charged by the constant current, and its voltage rises. When the voltage exceeds the reference voltage of the reference voltage supply 254, the output of the comparator 253 is inverted to the H level. The output of the comparator 253 is connected to the set terminal of an RS latch 255. When the output of the comparator 253 becomes the H level, the output of the RS latch 255, connected to the gate of the step-up switch 22, also becomes the H level, thereby closing the step-up switch 22.

On the other hand, the error between the output DC voltage Vo2 and the reference voltage of a voltage supply 257 is compared and amplified using an error amplifier 256. The error voltage output from the error amplifier 256 is compared with the voltage of a capacitor 259 using a comparator 258. The capacitor 259 is charged by a constant current using a current supply 260 and discharged to zero voltage using an N-channel FET 261 that is opened/closed by the inverted output of the RS latch 255. The output of the comparator 258 is connected to the reset terminal of the RS latch 255. In other words, when the step-up switch 22 is closed, the FET 261 is opened, and the capacitor 259 is charged from the zero voltage by the constant current. When its voltage reaches the error voltage, the output of the comparator 258 becomes the H level, and the RS latch 255 is reset. When the RS latch 255 is reset, the step-up switch 22 is opened, and the FET 261 is closed, thereby discharging the capacitor 259 to zero voltage.

As described above, the period of the closed state of the step-up switch 22 is a period from the predetermined time having passed after the voltage of the capacitor 251 has exceeded the reference voltage of the voltage supply 254 after the closing of the high-side switch 11 of the switching circuit 10 to the time when the voltage of the capacitor 259 has reached the error voltage. When the output DC voltage Vo2 becomes higher than the desired value, the error voltage lowers, the ON time during which the step-up switch 22 is closed is made shorter, and the output DC voltage Vo2 is lowered. Conversely, when the output DC voltage Vo2 becomes lower than the desired value, the error voltage rises, and the ON time of the step-up switch 22 is made longer, and the output DC voltage Vo2 is raised. In this way, the output DC voltage Vo2 is controlled so as to become constant and have the desired value.

The present invention is not limited to the control method described referring to FIG. 3 in the first embodiment. For example, the high-side switch 11 of the switching circuit 10 and the step-up switch 22 may be controlled so as to be closed at the same time. In the case of this control, the circuit shown in FIG. 3 should only be configured that a one-shot pulse is generated at the falling edge of the pulse voltage supplied from the pulse generation circuit 130 and that the one-shot pulse is input to the set terminal of the RS latch 255. The high-side switch 11 and the step-up switch 22 can be configured so as to be closed at the same time by setting the RS latch 255 at the falling edge of the pulse voltage as described above. Conversely, in the case that the RS latch 255 is set at the rising edge of the pulse voltage, the low-side switch 12 and the step-up switch 22 can be configured so as to be closed at the same time. Furthermore, the step-up switch 22 can be closed after a predetermined time has passed after the closing of the low-side switch 12, by inverting the pulse voltage and inputting the inverted pulse voltage to the gate of the FET 250.

### Second Embodiment

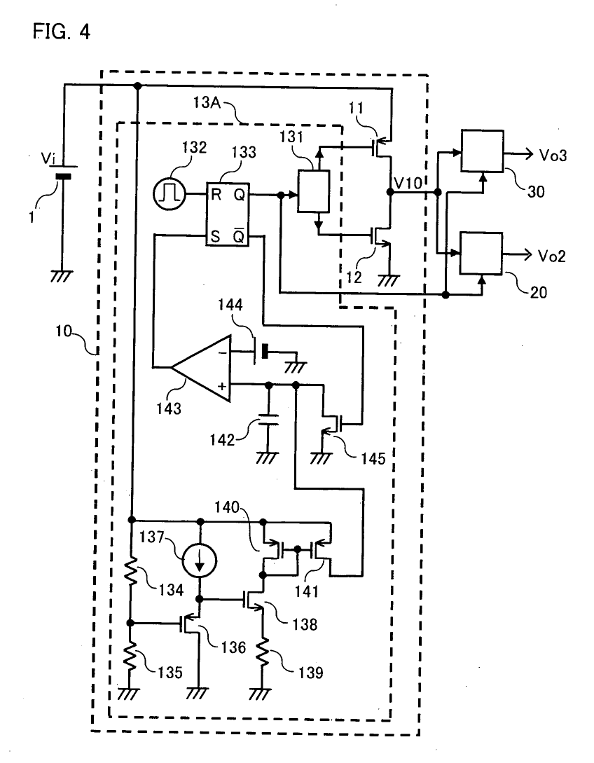

FIG. 4 is a circuit diagram showing the configuration of the main sections of a multi-output power supply circuit in accordance with a second embodiment of the present invention. In FIG. 4, the components having the same functions and configurations as those of the multi-output power supply circuit in accordance with the first embodiment described above and shown in FIG. 1 are designated by the same numerals, and the descriptions of the first embodiment are applied to their descriptions. The second embodiment differs from the first embodiment in the configuration of the step-down control circuit in the switching circuit 10. The step-down control circuit is thus described as a step-down control circuit 13A to distinguish it from the step-down control circuit 13 in accordance with the first embodiment.

The configuration of the drive circuit 131 of the step-down control circuit 13A shown in FIG. 4 is the same as the configuration of the drive circuit 131 shown in FIG. 3, which is configured so as to power-amplify the pulse voltage and to output the amplified pulse voltage to the gate of the high-side switch 11 and the gate of the low-side switch 12. A clock signal generator 132 outputs a clock signal having a predetermined cycle to an RS latch 133. The RS latch 133 receives the clock signal that is input to its reset terminal and outputs a drive signal to the drive circuit 131. The input DC voltage Vi is divided by a resistor 134 and a resistor 135. When it is assumed that the voltage ratio obtained in this way is α, a divided voltage αVi is input to the gate of a P-channel FET 136. The drain of the FET 136 is grounded, and the source thereof is connected to a current supply 137 and the gate of an N-channel FET 138. A constant current flows from the current supply 137 to the source of the FET 136. The source of the FET 138 is grounded via a resistor 139, and the drain thereof is connected to the drain and gate of a P-channel FET 140. The potential at the source of the FET 138, that is, the voltage applied to the resistor 139, is equal to αVi. Hence, when it is assumed that the resistance value of the resistor 139 is r, the current flowing through the FET 138 is represented by αVi/r. The P-channel FET 140 and a P-channel FET 141 constitute a current mirror, and the mirror current thereof serves as a charging current supplied to a capacitor 142 connected to the drain of the FET 141. The voltage of the capacitor 142 is compared with the reference voltage of a voltage supply 144 using a comparator 143. The output of the comparator 143 is connected to the set terminal of the RS latch 133. The inverting output of the RS latch is connected to the gate terminal of an N-channel FET 145, and the drain and source of the FET 145 are connected to the two terminals of the capacitor 142, respectively.

The potential at the source of the FET 138, that is, the voltage applied to the resistor 139, is equal to αVi. When it is assumed that the resistance value of the resistor 139 is r, the current flowing through the FET 138 is represented by αVi/r. Hence, this current serves as a charging current supplied to the capacitor 142 using the current mirror formed of the FET 140 and the FET 141. On the other hand, using the FET 145 that is opened/closed by the inverted signal of the drive signal, the capacitor 142 is short-circuited and discharged in the OFF period during which the high-side switch 11 is open. When the RS latch 133 is reset by the clock signal and the high-side switch 11 is closed, the FET 145 is opened, the capacitor 142 is charged by the current αVi/r. When the voltage of the capacitor 142 is raised and exceeds the reference voltage of the voltage supply 144, the output of the comparator 143 is inverted to the H level. As a result, the RS latch 133 is set, the drive signal has the H level, and the high-side switch 11 is opened. Therefore, when it is assumed that the capacitance of the capacitor 142 is C and that the reference voltage of the voltage supply 144 is E, the ON period during which the high-side switch 11 is closed is represented by C·E·r/(αVi). Hence, the duty ratio D1 is inversely proportional to the input DC voltage Vi.

Like the first embodiment described above, the second embodiment is described so as to be configured that the step-down control circuit 13A fixes the duty ratio D1 and that the high-side switch 11 and the low-side switch 12 are controlled so as to be opened/closed. However, by adjusting the duty ratio D1 so that Vi×D1 becomes constant, in other words, by adjusting the duty ratio D1 so that it is inversely proportional to the input DC voltage Vi, the step-down control circuit 13A can approximately stabilize Vi×D1 to a predetermined value being equal to or less than the minimum value of the desired output DC voltages in response to the change in the input DC voltage Vi.

### Third Embodiment

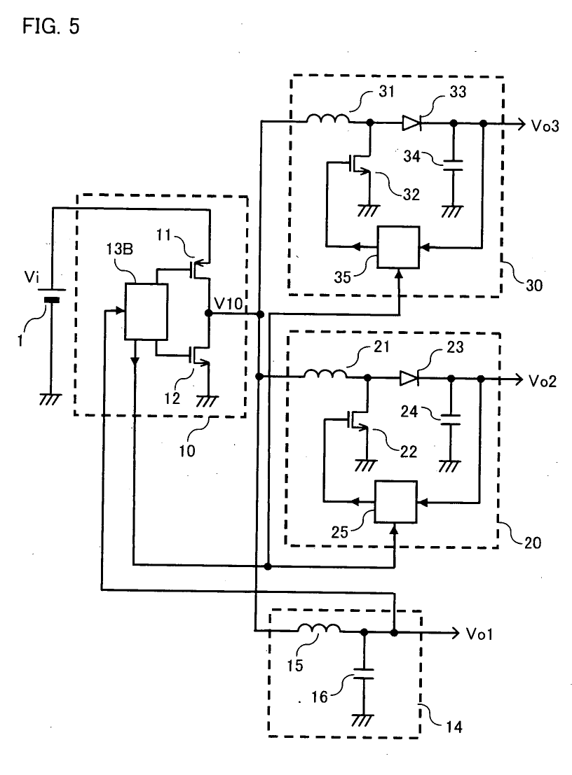

FIG. 5 is a circuit diagram showing the configuration of the main sections of a multi-output power supply circuit in accordance with a third embodiment of the present invention. In FIG. 5, the components having the same functions and configurations as those of the multi-output power supply circuit in accordance with the first embodiment described above and shown in FIG. 1 are designated by the same numerals, and the descriptions of the first embodiment are applied to their descriptions. The third embodiment differs from the first embodiment in that a smoothing circuit 14 for outputting a first output DC voltage Vo1 is connected to the output terminal of a switching circuit 10 and in that the function of the step-down control circuit is changed to stabilize the first output DC voltage Vo1. In response to this change, the step-down control circuit is referred to as a step-down control circuit 13B so that it is distinguished from the step-down control circuit 13 in accordance with the first embodiment. The smoothing circuit 14 comprises an inductor 15 and a capacitor 16. One terminal of the inductor 15 is connected to the output terminal of the switching circuit 10, and the other terminal of the inductor 15 is connected to one electrode of the capacitor 16. The other electrode of the capacitor 16 is grounded, and the first output DC voltage Vo1 is output from the capacitor 16.

The operation of the multi-output power supply circuit in accordance with the third embodiment will be described below.

First, since the high-side switch 11 and the low-side switch 12 are opened/closed alternately, the output terminal voltage V10 of the switching circuit 10 has a rectangular-wave voltage, the amplitude of which is the input DC voltage Vi. This rectangular-wave voltage is averaged using the smoothing circuit 14 and is output as the first output DC voltage Vo1. When it is assumed that the ratio of the ON time during which the high-side switch 11 is closed with respect to the switching cycle T is herein referred to as a duty ratio D1, the first output DC voltage Vo1 is represented by Expression (8) described below.
Vo1=Vi×D1 (8)

In other words, the switching circuit 10 and the smoothing circuit 14 constitute a step-down circuit.

Next, the second output DC voltage Vo2 that is output via the first step-up circuit 20 is represented by Expression (9) described below using the duty ratio D2 of the step-up switch 22.
Vo2=Vi×D1/(1−D2) (9)

In addition, the third output DC voltage Vo3 that is output via the second step-up circuit 30 is represented by Expression (10) described below using the duty ratio D3 of the step-up switch 32.
Vo3=Vi×D1/(1−D3) (10)

Hence, the second output DC voltage Vo2 and the third output DC voltage Vo3 are respectively similar to the output DC voltage Vo2 and the third output DC voltage Vo3 in the first embodiment described above. Since Vo1=Vi×D1, the output DC voltages Vo2 and Vo3 are represented by Expressions (11) and (12) described below, respectively.
Vo2=Vo1/(1−D2) (11)
Vo3=Vo1/(1−D3) (12)

As described above, the multi-output power supply circuit in accordance with the third embodiment of the present invention can control one step-down output and at least one step-up/down output.

The multi-output power supply circuit in accordance with the present invention is highly versatile and useful for a power supply having multiple outputs including outputs that can be step-up/down controlled with respect to an input DC voltage.

Although the present invention has been described with respect to its preferred embodiments in some detail, the disclosed contents of the preferred embodiments may change in the details of the structure thereof, and any changes in the combination and sequence of the component may be attained without departing from the scope and spirit of the claimed invention.

1. A multi-output power supply circuit comprising:
a switching circuit having a series circuit of a high-side switch and a low-side switch, which are connected in parallel with an input DC power supply, and a step-down control circuit for alternately opening/closing said high-side switch and said low-side switch, and
multiple step-up circuits each connected to the connection point of said high-side switch and said low-side switch.

2. The multi-output power supply circuit in accordance with claim 1, wherein said step-up circuit comprises:
an inductor, one terminal of which is connected to the connection point of said high-side switch and said low-side switch,
a step-up switch and a step-up rectifier connected to the other terminal of said inductor,
smoothing means, connected to said step-up rectifier, for outputting an output DC voltage, and
a step-up control circuit for controlling the ON/OFF operation of said step-up switch so as to control said output DC voltage.

3. The multi-output power supply circuit in accordance with claim 1, wherein said step-down control circuit and said step-up control circuit drive said high-side switch and said low-side switch, and said step-up switch, respectively, at the same switching frequency.

4. The multi-output power supply circuit in accordance with claim 1, wherein said step-down control circuit is configured that the ratio of the ON time with respect to the switching cycle of said high-side switch is set so as to be equal to or less than the ratio of the minimum value of the output DC voltages output from said multiple step-up circuits with respect to the input voltage output from said input DC power supply.

5. A multi-output power supply circuit comprising:
a switching circuit having a series circuit of a high-side switch and a low-side switch, which are connected in parallel with an input DC power supply, and a step-down control circuit for alternately opening/closing said high-side switch and said low-side switch,
a smoothing circuit, connected to the connection point of said high-side switch and said low-side switch, for outputting a first output DC voltage, and
at least one step-up circuit connected to the connection point of said high-side switch and said low-side switch.

6. The multi-output power supply circuit in accordance with claim 5, wherein said step-up circuit comprises:
an inductor, one terminal of which is connected to the connection point of said high-side switch and said low-side switch,
a step-up switch and a step-up rectifier connected to the other terminal of said inductor,
smoothing means, connected to said step-up rectifier, for outputting an output DC voltage, and
a step-up control circuit for controlling the ON/OFF operation of said step-up switch so as to control said output DC voltage.

7. The multi-output power supply circuit in accordance with claim 5, wherein said smoothing circuit comprises an inductor, one terminal of which is connected to the connection point of said high-side switch and said low-side switch, and a capacitor connected to the other terminal of said inductor so as to output said first output DC voltage from across said capacitor.

8. The multi-output power supply circuit in accordance with claim 5, wherein said step-down control circuit controls the ON/OFF operation of said high-side switch and said low-side switch so as to control said first output DC voltage.

9. The multi-output power supply circuit in accordance with claim 6, wherein said step-down control circuit and said step-up control circuit drive said high-side switch and said low-side switch, and said step-up switch, respectively, at the same switching frequency.
